(19) United States
(12) Patent Application Publication
(10) Pub. No.: US 2015/0010830 A1
(43) Pub. Date: Jan. 8, 2015

(54) GERMANIUM NANOPARTICLE/CARBON COMPOSITE ANODE MATERIAL USING NO BINDER FOR LITHIUM-POLYMER BATTERY HAVING HIGH CAPACITY AND HIGH RAPID CHARGE/DISCHARGE CHARACTERISTICS

(71) Applicant: POSTECH ACADEMY-INDUSTRY FOUNDATION, Pohang-si (KR)

(72) Inventors: Moon Jeong Park, Pohang-si (KR); Gyuha Jo, Busan (KR)

(21) Appl. No.: 14/380,452

(22) PCT Filed: Oct. 17, 2012
(86) PCT No.: PCT/KR2012/008462

§ 371 Date: Aug. 22, 2014

(30) Foreign Application Priority Data
Feb. 23, 2012 (KR) 10-2012-0018279

(51) Int. Cl. H01M 4/36; H01M 10/0525; H01M 4/04; H01M 10/0565; H01M 4/133; H01M 4/587; H01M 4/136; H01M 4/58

(52) U.S. Cl. CPC H01M 4/366; H01M 4/136; H01M 10/0525; H01M 4/58; H01M 10/0565; H01M 4/133; H01M 4/587; H01M 4/0404; H01M 2004/027
USPC 429/309; 429/231.8; 429/231.4; 427/122

(57) ABSTRACT

The present invention relates to an anode active material for a lithium-polymer battery having high capacity and high rapid charge/discharge characteristics, and a lithium-polymer battery using the same, and more specifically, to: a non-carbonaceous nanoparticle/carbon composite anode material using no binder; a lithium-polymer battery having high capacity and high rapid charge/discharge characteristics using the same; and a preparation method thereof. According to the present invention, the lithium-polymer secondary battery comprises an anode active material prepared by carbonizing a composite in which polymer particles comprising non-carbonaceous nanoparticles are dispersed in a polymer resin. According to the present invention, the anode active material allows non-carbonaceous nanoparticles to be dispersed in and fixed to a carbonized body even without a binder.

### TECHNICAL FIELD

The present invention relates to an anode active material for a lithium-polymer battery having high capacity and high charge/discharge rate capability, and a lithium-polymer battery using the same. More particularly, the present invention relates to a binderless, non-carbonaceous nanoparticle/carbon composite anode material; a lithium-polymer battery having high capacity and high charge/discharge rate capability, using the same; and a preparation method thereof.

### BACKGROUND ART

There has recently been an increase in public concern over a predicted energy crisis, and thus demand for new, high-efficiency energy sources as alternatives to fossil fuel has led to the consequent encouragement of research into secondary cells, in particular, lithium ion batteries. Currently, lithium ion batteries are widely studied for use in small electronic appliances, but are still in need of much improvement in terms of performance for medium to large scale energy storage, such as in electric vehicles. To enhance the performance of lithium ion batteries, studies have been focused on the development of new materials characteristic of high electric capacity, long battery life span, and high charge/discharge capability. As a result, new anode materials which are higher in theoretical electric capability than carbon (theoretical electric capability 372 mAh/g) have been developed. Of the elements in Group 4, silicon and germanium have attracted keen interest as the most promising next-generation materials because their theoretical electric capacities are as high as approximately 4200 mAh/g and 1600 mAh/g. Varied research has been made into anode materials based on silicon or germanium. Among them is a morphological design for facilitating the delivery of lithium. For both silicon and germanium, it is already demonstrated that the size reduction of the active materials to the nanometer scale is the most effective approach to the achievement of reversible electric capacity because of high charge rage and reduced steric hindrance. For example, silicon nanowires were reported to have an electric capability of 3000 mAh/g even at slow charge/discharge rates (X. Chen et al., Adv. Funct. Mater., 2011, 21, 380).

In spite of its advantage of having a higher electric capacity over germanium, silicon has charge/discharge rate restrictions due to low lithium ion diffusion thereinto. One of the factors indispensable to the development of lithium ion batteries of high capacitance is to withstand rapid charge/discharge rates. In this context, germanium is significantly advantageous over silicon because its lithium diffusion coefficient is hundreds times as high as that of silicon. In lithium ion batteries, germanium may be used in its pure form or as an alloy. Particularly, as many cycles of charge/discharge are performed, an electrode loses its mechanical properties or the nanosized germanium particles are all tangled up. As a solution to this problem, covering germanium with carbon is being employed. The carbon, which acts a sheath, can buffer volumetric change during the charge/discharge of germanium (Hyojin Lee et al., Electrochem. Soc. 2007, 154(4), A343; Min-Ho Seo et al., Energy Environ. Sci. 2011, 4, 425). However, there have been no strategies for uniformly dispersing an active material over a carbon substrate.

### DISCLOSURE

### Technical Problem

It is an object of the present invention to provide a method for simply preparing non-carbonaceous particles, particularly, germanium nanoparticles having a highly controlled distribution over a carbon substrate.

It is another object of the present invention to provide binderless, carbon-covered germanium nanoparticles well-distributed over a carbon substrate, which are fundamentally prevented from being tangled up by additional carbon or a binder.

It is a further object of the present invention to provide a germanium-based anode material for secondary lithium polymer batteries, which has a reversible electric capacity of 1600±50 mAh/g and exhibits a high charge/discharge capability as demonstrated by experiments using a charge/discharge rate of 1C, 2C, 5C, and 10C.

### Technical Solution

In order to achieve the above-mentions objects, the present invention provides a method for preparing an anode material for secondary batteries, comprising coating a current collector with a mixture of non-carbonaceous nanoparticles, a block copolymer, and a thermosetting resin, curing the mixture, and carbonizing the mixture.

The current collector may be made of a conductive metal, preferably copper or aluminum, which is robust enough to withstand carbonization.

The non-carbonaceous nanoparticles may be silicon, germanium or antimony particles, and preferably may be or include germanium particles, which allows lithium ions to diffuse at a high rate therein..

In a preferred embodiment, the non-carbonaceous nanoparticles may be modified on their surfaces with an organic functional group suitable to increase compatibility with the block copolymer. The organic functional group for modification may be aliphatic, cyclic, or aromatic as represented by CnHm (wherein n and m are both an integer of 1 or larger). The aliphatic organic group may contain 1 to 30 carbon atoms, examples of which include alkyl groups of 1 to 30 carbon atoms, e.g., an alkyl group of 1 to 15 carbon atoms;

alkenyl groups of 2 to 30 carbon atoms, e.g., an alkenyl group of 2 to 18 carbon atoms; or alkynyl groups of 2 to 30 carbon atoms, e.g., an alkynyl group of 2 to 18 carbon atoms. The cyclic organic group may contain 3 to 30 carbon atoms, examples of which include cycloalkyl groups of 3 to 30 carbon atoms, e.g., a cycloalkyl group of 3 to 18 carbon atoms; cycloalkenyl groups of 3 to 30 carbon atoms, e.g., a cycloalkenyl group of 3 to 18 carbon atoms; and cycloalkynyl groups of 3 to 30 carbon atoms, e.g., a cycloalkynyl group of 5 to 18 carbon atoms. As for the aromatic organic group, its number of carbon atoms may range from 6 to 30. Aryl groups of 6 to 30 carbon atoms, e.g., aryl groups of 6 to 18 carbon atoms may be used. Concrete examples of the organic functional groups include methyl, ethyl, propyl, butyl, cyclopropyl, cyclobutyl, cyclopentyl, cyclohexyl and phenyl, but are not limited thereto. The modification of non-carbonaceous materials with organic functional groups is well known to those having ordinary skill in the art, and thus, its description is omitted.

Turning to the block copolymer, preferable is a self-assembly block copolymer containing a block compatible with the organic modifier. Without theoretical limitations, the block copolymer is composed of inner and outer blocks which are relatively more and less compatible with the non-carbonaceous nanoparticles, respectively, so that the carbonaceous nanoparticles can be located inside the block copolymer. In one embodiment of the present invention, when the surface of the non-carbonaceous nanoparticles is modified with a butyl group, the block copolymer may contain a block compatible with the butyl group, for example, a polyisoprene block.

Compatibility between the organic modifier and the block copolymer may be determined using difference in solubility constant therebetween. Typically, two materials are regarded compatible with each other when their difference in solubility constant is less than approximately 4 MPa^{1/2}.

Without theoretical limitations, the thermosetting resin is used to keep the non-carbonaceous nanoparticles from being dispersed within the block copolymer after the carbonization. Various thermosetting resins such as phenol resins, melamine resins, and alkyd resins may be used.

The mixture of the non-carbonaceous nanoparticles, the block copolymer and the thermosetting resin may be obtained by mixing the non-carbonaceous nanoparticles with the block copolymer, and then the non-carbonaceous nanoparticle-containing block copolymer with the thermosetting resin so as to improve the dispersion of the non-carbonaceous nanoparticles.

In this regard, the weight ratio of the non-carbonaceous nanoparticle-containing block copolymer to the thermosetting resin may vary in the range of 20:8080:20, depending on the secondary battery's charge capacity or preparation conditions, and preferably may be 70:30. Also, the non-carbonaceous nanoparticles may be mixed at a weight ratio of 10:9090:10 with the block copolymer, depending on the secondary battery's charge capacity or preparation conditions.

The coating step may be carried out by applying a solution of non-carbonaceous nanoparticles, a block copolymer and a thermosetting resin to a current collector and then drying the solution. The curing of the thermosetting resin may be completed by a further curing process after the mixing, curing and coating processes. The curing may be executed at typical curing temperature, and preferably at 60° C. for 1 hr before coating, and for 3 hrs after coating.

As in a typical carbonization process, the carbonizing may be performed at around 800° C. and preferably in an inert atmosphere.

In accordance with an aspect of the present invention, the anode for secondary batteries has a non-carbonaceous nanoparticle-dispersed, conductive carbide film formed on the surface of the current collector.

The conductive carbide film is a film composed essentially of non-carbonaceous nanoparticles and a carbide, which is free of a binder and can be applied to a current collector without use of a binder.

According to the present invention, the non-carbonaceous nanoparticles are preferably germanium particles. In one embodiment, the germanium particles are crystalline germanium particles.

The carbide film is a thin film formed by carbonizing the non-carbonaceous nanoparticle-dispersed thermosetting thin film. Herein, the thermosetting thin film is a thin film containing a thermosetting resin. In one embodiment of the present invention, the thin film may be formed by curing the thermosetting resin in which the block copolymer containing the non-carbonaceous nanoparticles therein is distributed.

In one embodiment of the present invention, the non-carbonaceous nanoparticles have a size of 1-40 nm, and preferably a size of 10-30 nm, and the block copolymer particles containing the non-carbonaceous nanoparticles therein range in size from 50 to 500 nm, and preferably from 100 to 200 nm.

Unless given a clear expression such as “after charge/discharge,” sizes of the nanoparticles mean sizes of the nanoparticles in an initial state where lithium secondary batteries do not undergo charge/discharge operations.

In accordance with another aspect thereof, the present invention addresses a lithium polymer battery comprising an anode composed of a current collector on the surface of which non-carbonaceous nanoparticles are dispersed; a cathode; and an electrolyte.

The cathode may be a typical one used in lithium polymer secondary batteries. In one embodiment of the present invention, the cathode may be fabricated by preparing a cathode active material solution with a cathode active material, a binder, and a solvent, and directly coating an aluminum current collector with the cathode active material solution. Alternatively, the cathode may be fabricated by casting the cathode active material solution to a support to form a cathode active material film, peeling off the cathode active material film from the support, and laminating the cathode active material film on a copper current collector. If necessary, the cathode active material solution may further contain a conductive material. The cathode active material may be capable of intercalation/deintercalation of lithium ions, and may be exemplified by metal oxides, lithium complex metal oxides, lithium complex metal sulfides, and lithium complex metal nitrides, but is not limited thereto.

As the electrolyte, a non-aqueous electrolyte or a known solid electrolyte may be used, and a lithium salt may be dissolved therein. Examples of a solvent used for the non-aqueous electrolyte include, but are not limited to, cyclic carbonates, such as ethylenecarbonate, diethylenecarbonate, propylenecarbonate, butylenecarbonate, and vinylenecarbonate; chain carbonates, such as dimethylcarbonate, methylethylcarbonate, and diethylcarbonate; esters, such as methylacetate, ethylacetate, propylacetate, methylpropionate, ethylpropionate, and γ-butyrolactone; ethers, such as 1,2-dimethoxyethane, 1,2-diethoxyethane, tetrahydrofuran, 1,2-dioxane, and 2-methyltetrahydrofuran; nitriles, such as acetonitrile; and amides, such as dimethylformamide. These solvents may be used alone or in combination. Preferred is a combination of a cyclic carbonate and a chain carbonate.

A gel electrolyte, such as that prepared by impregnating a polymer, e.g. polyethylene oxide, polyacrylonitrile, etc., with an electrolyte solution, or an inorganic solid electrolyte, such as LiI, Li₃N, etc. may also be employed in the present invention. In this context, the lithium salt may be selected from the group consisting, but not limited to, LiPF₆, LiBF₄, LiSbF₆, LiAsF₆, LiClO₄, LiCF₃SO₃, Li (CF₃SO₂) ₂N, LiC₄F₉SO₃, LiSbF₆, LiAlO₄, LiAlO₂, LiAlCl₄, LiCl, and LiI.

In one embodiment of the present invention, the electrolye may be a polymer electrolyte employing a mixture of a PS:PEO block copolymer and PEO, optionally doped with Li ions. With regard to the electrolyte, reference may be made to Korean Patent Laid-Open Publication Nos. 2012-0109905 and 2012-0109908, which are incorporated herein by reference in their entities.

In accordance with another aspect thereof, the present invention addresses a thermoset thin film in which polymer particles comprising germanium nanoparticles are dispersed.

In accordance with another aspect thereof, the present invention addresses a thin film composition, comprising, germanium nanoparticles, a block copolymer, and a thermosetting resin.

In accordance with another aspect thereof, the present invention addresses a method in which non-carbonaceous nanoparticles modified with an organic functional group are mixed with a block polymer similar in solubility constant to the organic functional group, and the mixture is dispersed on a polymer thin film.

In accordance with another aspect thereof, the present invention addresses a method for fabricating a lithium polymer secondary battery, comprising: modifying non-carbonaceous nanoparticles with an organic functional group; mixing the modified non-carbonaceous nanoparticles with a block copolymer compatible with the organic functional group; mixing the mixture of the non-carbonaceous nanoparticles and the block copolymer with a thermosetting resin; applying the resultant mixture to a current collector and curing the resultant mixture to form a thin film; and carbonizing the thin film.

In accordance with another aspect thereof, the present invention addresses a composite thin film comprising a thermosetting resin in which polymer particles containing non-carbonaceous nanoparticles are dispersed, and a method for preparing the same. The composite thin film is made conductive by carbonization and can be used as an anode active material of a secondary battery.

### Advantageous Effects

As described hitherto, the present invention offers a novel strategy for fabricating an anode through one carbonization process of germanium nanoparticles well-disperved on a carbon matrix with the aid of a self-assembly polymer and a thermocurable polymer.

The germanium nanoparticle/carbon hybrid electrode of the present invention was found to have an electric capacity of 1600±50 mAh/g, with a coulombic efficiency of 90% or higher, during 50 cycles of charge/discharge at a rate of 1C, as measured in half-cell experiments using a polymer electrolyte. Surprisingly, the hybrid electrode also allows charge/discharge cycles to proceed even at a rate of as high as 10C, with the coulombic efficiency reaching 98%. Particularly, free of insulating polymer binders, the hybrid electrode of the present invention opens a new field for electrode materials of lithium ion batteries.

### DESCRIPTION OF DRAWINGS

FIG. 1 is a schematic view illustrating the fabrication of a germanium nanoparticle/carbon hybrid electrode by dispersing germanium nanoparticles in PS-PI, fixing the nanostructures with a polymer, and coating a current collector with the nanostructures, and curing the nanostructures in a stepwise manner.

FIG. 2 is a representative bright field TEM image of a germanium nanoparticles/PS-PI/thermoset polymer mixture before pyrolysis. Five to eight germanium particles are observed to be fixed in one PS-PI particle with a diameter of around 120 nm. The PI domains are stained with OsO₄ to provide contrast to the image.

FIG. 3 is an FIB-TEM image of a longitudinal cross section of a hybrid electrode after carbonization. Germanium nanoparticles with a size of 10 nm are well dispersed across a carbon-based matrix as demonstrated by the TEM image of high magnification and the histogram insert.

FIG. 4 shows XRD spectra before (a) and after carbonization (b). Before carbonization, the germanium particles are amorphous. Characteristic peaks corresponding to crystalline germanium are detected after carbonization as shown in the spectra. In the HRTEM insert of FIG. 4b, crystalline germanium nanoparticles are also observed to be sheathed with carbon.

FIG. 5 shows data obtained in half-cell experiments with (a) a germanium nanoparticle/carbon hybrid electrode; (b) germanium nanoparticles alone, devoid of polymers. Half-cell experiments were performed with regard to lithium metal using a LiClO₄-doped polymer electrolyte at a rate of 1C in a potential range of 0.01-2.5V; (c) a hybrid electrode and an electrode devoid of a polymer. Charge/discharge profiles are depicted, together with the coulombic efficiency of the hybrid electrode on the right axis; and (d) a hybrid electrode. Charge/discharge cycles were conducted at 65° C. with the charge/discharge rate increasing from 1C to 2C, 5C, and 10C, and returned back to 1C.

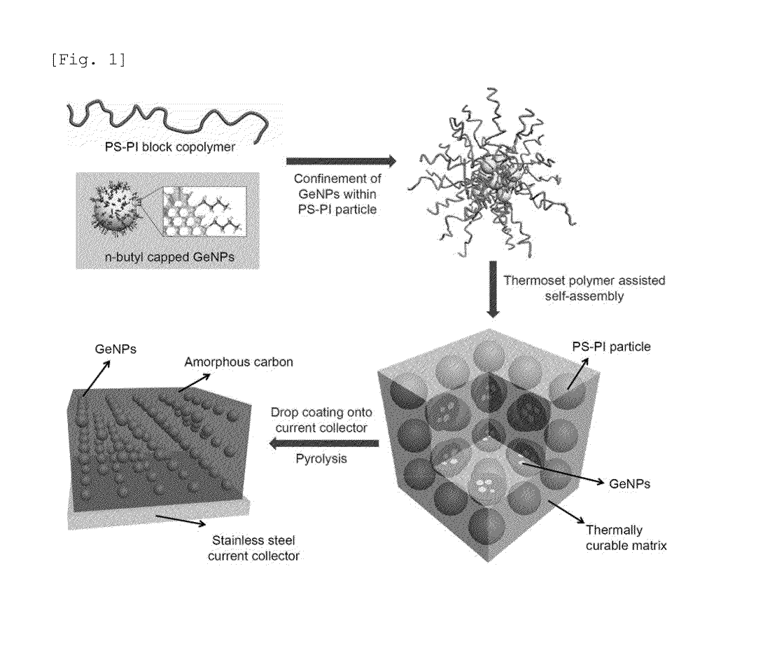

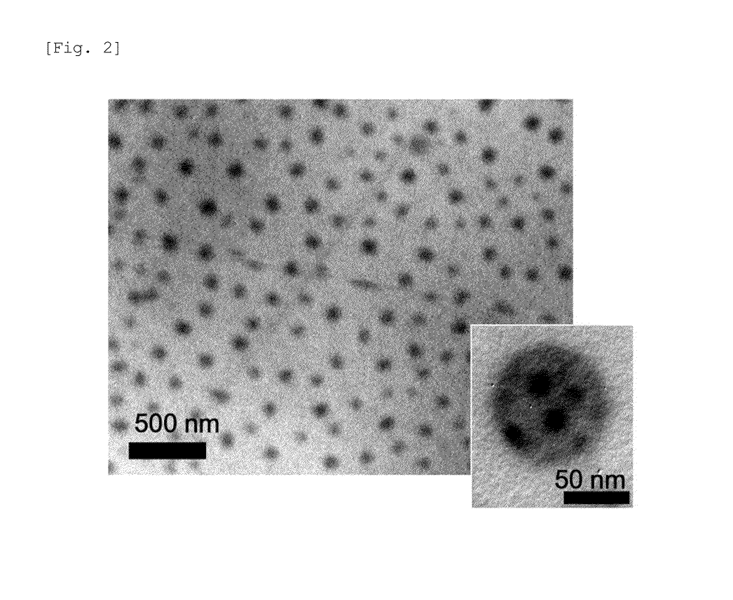

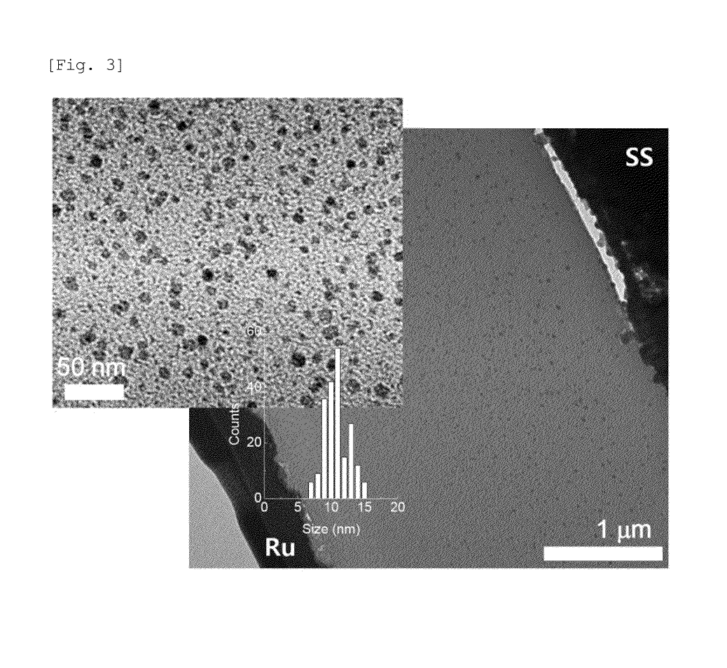

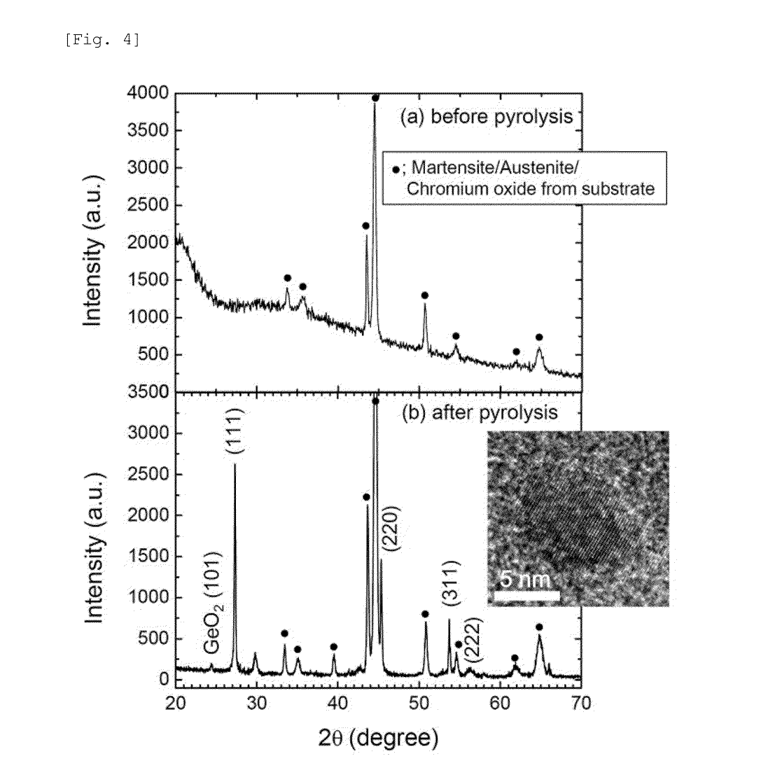

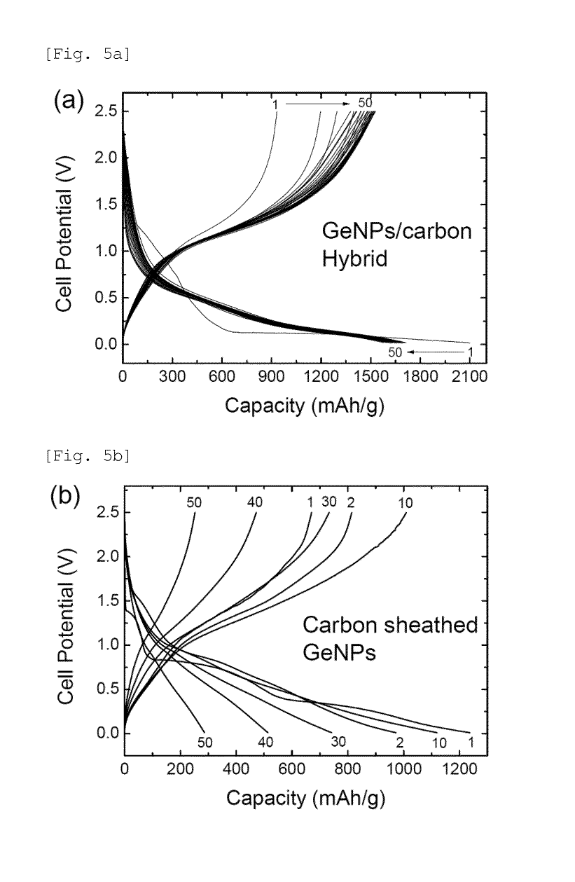

### MODE FOR INVENTION

A better understanding of the present invention may be obtained through the following examples which are set forth to illustrate, but are not to be construed as limiting the present invention.

### EXAMPLES

### Cell Fabrication

Synthesis of Germanium Nanoparticles Modified on Surface with n-butyl Group

Anhydrous glyme (1,2-dimethoxyethane) was purchased from Aldrich, and used without further purification. In an argon-filled glove box, GeCl₄ (1.2 g) was dissolved in glyme (50 mL). Sodium naphthalide, serving as a reductant, was obtained as a dark green solution by stirring a solution of sodium (0.69 g; 30 mmol) and naphthalene (2.6 g; 20 mmol) in glyme (150 mL) for 2 hrs or longer. Subsequently, the sodium naphthalide solution was introduced to the diluted GeCl₄ solution, and stirred for 2 hrs during which the germanium was reduced as demonstrated by the appearance of a clear orange solution and dark brown precipitates. Subsequently, the orange solution was transferred to a round-bottom flask. As soon as 6 mL of a 2.0 M n-butyllithium solution was added to the flask, the orange solution turned bright yellow, with the concomitant generation of white precipitates. Germanium nanoparticles modified on the surface with n-butyl, thus synthesized, were extracted with n-hexane while the remaining naphthalene was removed by sublimation. This procedure was repeated until clear yellow liquid was obtained.

Synthesis of germanium nanoparticles/carbon composite anode active material

Poly(styrene-b-isoprene) (PS-b-PI, 46-b-25 kg mol⁻¹, Mw/Mn=1.04) was synthesized by high-vacuum anionic polymerization (N. Hadjichristidis et al., Polym. Sci., Part A: Polym. Chem. 2000, 38, 3211). Because polyisoprene (PI) was expected to exhibit high selectivity thanks to its solubility constant similar to that of the butyl group introduced to the germanium nanoparticles, isoprene was copolymerized with styrene to form PS-PI nanostructures. Thereafter, the germanium nanoparticles were introduced to PS-PI nanostructures. In this regard, predetermined amounts of the PS-PI, and the n-butyl-surface modified germanium nanoparticles were dissolved in a mixture of toluene and n-hexane (70:30 vol. %). A thermosetting polymer was prepared by mixing 0.4 g of 2,4,6-tris(dimethylamino methyl)phenol, 4.4 g of nadic methyl anhydride, 5.4 g of dodecenylsuccinic anhydride, and 10.2 g of Poly/Bed 812, all purchased from Polyscience. The PS-PI containing the germanium nanoparticles was mixed at a weight ratio of 70:30 with the thermosetting polymer, followed by dissolving the mixture in THF. While the resulting solution was vigorously stirred, curing was conducted at 65° C. for 1 hr. The resulting solution was poured over a mirror-polished stainless steel substrate (SS) and left to the complete evaporation of the solvent. The thin film thus obtained was further cured at 65° C. for an additional 3 hrs, followed by carbonization at 800° C. for 1 hr under a flow of argon and hydrogen. In this context, the temperature was increased at a fixed rate of 20° C. per min.

Preparation of Polymer Electrolyte Poly(styrene-b-ethylene oxide) (PS-b-PEO, 22-b-35 kg mol⁻¹, Mw/Mn=1.08) was synthesized by high-vacuum anionic polymerization. This PS-PEO and a PEO homopolymers (3.4 kg/mol, purchased from Aldrich) were mixed at a weight ratio of 80:20, and the PEO moieties were doped with LiClO₄ at a fixed rate of [Li+]/[EO]=0.056. For use in the doping, LiClO₄ and the polymers were dissolved in a mixture of 1:1 THF and methanol. After the resulting solution was stirred overnight at room temperature, the electrolyte thus dried was pressed to a thickness of 200 μm at 80° C. under a pressure of 2000 psi. The polymer electrolyte thus obtained was measured for through-plane conductivity using an in-house fabricated cell. A

Solartron 1260 frequency response analyzer with a Solartron 1296 dielectric interface was used for the collection of impedance and capacitance spectra. All procedures were conducted in an argon-filled glove box with a water content of 0.1 ppm kept therein.

Half Cell Experiment Using Coin-Type Battery

The binderless germanium nanoparticles synthesized through a pyrolysis process and the carbon hybrid anode active material were employed in a half-cell experiment. This experiment was carried out with an in-house fabricated, coin-type battery using the synthesized anode material, the polymer electrolyte, and the lithium thin film. For this, the charge/discharge rate varied from 1C to 10C (1C=1600 mAg⁻¹) at a temperature of 65° C.

Microstructure Analysis

For microstructure analysis, a mixture of the n-butyl-modified germanium nanoparticles, PS-PI, and the thermosetting polymer was cured to give a sample in which a nanostructure was fixed (before pyrolysis), and the sample was sectioned at −120° C. to a thickness of 80-120 nm using RMC Boeckeler PT XL

Ultramicrotome. The sections were stained for 50 min with osmium tetroxide (OsO4) vapor to enhance electrical contrast. After pyrolysis, longitudinal cross-sectional samples of an anode material composed of the germanium nanoparticles, carbon, and SS were obtained at 30 keV by FEI Strata 235 Dual Beam focused-ion beam (FIB) using a gallium ion beam. The samples were subjected at an acceleration voltage of 200 kV to TEM using JEOL JEM-2100F microscope. X-ray diffraction of the anode material was carried out in POSTECH (Rigaku D/MAX-2500, CuKα, λ=1.54 Å). Synchrotron SAXS for the structural analysis of polymer electrolytes was carried out using 10C SAXS beamline at Photon Factory, Japan.

Charge/Discharge Experiment

The germanium nanoparticles/carbon hybrid anode material was examined for electrical properties by galvanostatic discharge/charge experiments. For a half-cell experiment, a lithium metal thin film, a polymer electrolyte, and the synthesized hybrid electrode were employed. The lithium metal thin film and the polymer electrolyte were, respectively, 380 pm and 200 μm thick. The polymer electrolyte was prepared by mixing PS-PEO (22-35 kg/mol) at a ratio of 8:2 with a PEO (3.4 kg/mol) homopolymers, with the PEO moieties doped with LiClO₄ at a fixed rate of [Li⁺]/[EO]=0.056. The doped polymer electrolye has a lamellar structure, with a domain size of 31.4 nm. SAXS experiments were performed on the PS-PEO (22K-35K)/PEO (3.4K) mixture before and after the doping. A half-cell experiment was carried out at 65° C., with the polymer electrolyte found to have a conductivity of 4×10⁻⁴ S/cm at this temperature.

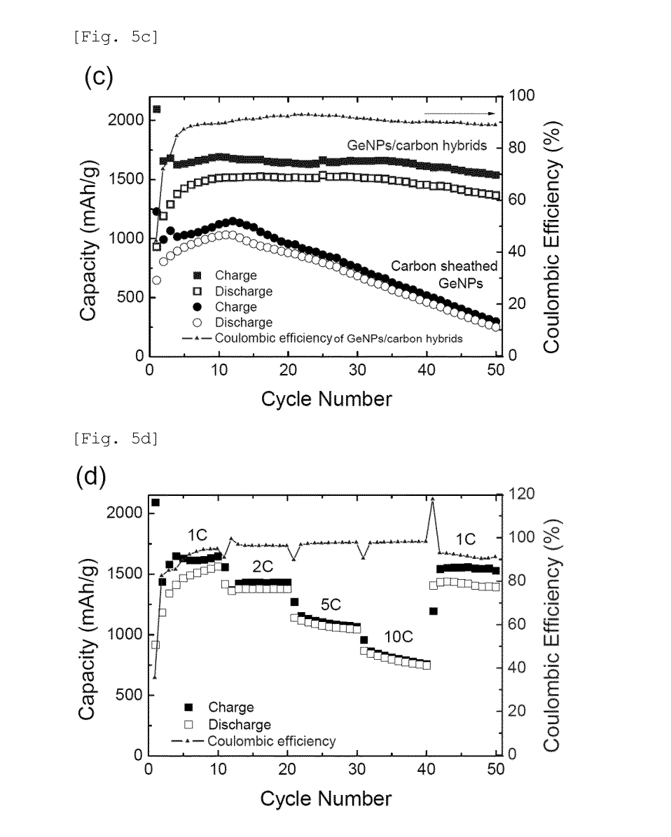

The germanium nanoparticles/carbon hybrid electrode was subjected to 50 cycles of charge (association of lithium with the anode material) and discharge (dissociation of lithium at the anode) at 1C rate (1C=1600 mA/g, charge/discharge rates were the same) in a voltage range of 0.01˜2.5V. Charge/discharge profiles for cell potentials are depicted as a function of capacity in FIG. 5a. The charge capacity reached 2096 mAh/g at the first charge, and decreased to 1655 mAh/g from the second cycle. Then, the charge capacity was fluctuated in the range of 1600±50 mAh/g, with a coulombic efficiency of 90% or higher.

### Comparative Example

The same half-cell experiment was performed, with the exception that the germanium nanoparticles alone, devoid of the PS-PI and the thermoset polymer, were carbonized. Significantly different electrical properties were detected. As shown in FIG. 5b, this carbon-sheathed electrode had a charge/discharge capacity of 1227/646 mAh/g at a first cycle, which was significantly lower than that of the carbon hybrid electrode. At the first charge/discharge, only a coulombic efficiency of 53% was obtained. With the progression of charge/discharge cycles, the electrode was found to have gradually reduced electric capacity. A significantly low electric capacity was obtained at the 50^{th} cycle.

50 Cycles of Charge/Discharge In FIG. 5c, charge/discharge profiles are depicted during 50 cycles of charge/discharge on the germanium nanoparticles/carbon hybrid electrode and the carbon-sheathed germanium nanoparticle electrode. For the hybrid electrode, the coulombic efficiency was observed to sharply increase in first several cycles, but was finally stabilized to around 91±2% from then. At the 50^{th} cycle, the electrode material had charge/discharge capacities of 1550 and 1389 mAh/g, respectively, with a coulombic efficiency of 90%. In contrast, as is understood from data of FIG. 5c, the simply carbonized germanium nanoparticles, although sheathed with carbon, gradually decreased in electric capacity after the stable progression of charge/discharge to the 12^{th} cycle. At the 50^{th} cycle, the electrode retained only 24% of the initial electric capacity.

Experiments for High Charge/Discharge Rate

From the experiments, the surprising result was obtained that the germanium nanoparticles/carbon hybrid electrode withstood the high charge/discharge rate 10C. FIG. 5d shows charge/discharge profiles of the electrode while the charge/discharge rate was increased from 1C to 2C, 5C and 10C, and then, returned back to 1C. At each charge/discharge rate, 10 cycles were performed. When the charge/discharge was increased from 1C to 2C, the charge capacity was observed to reduce from 1614 to 1426 mAh/g. From then, the electric capacity remained 54% or higher in the charge/discharge experiments performed to a rate of 10C, with a coulombic efficiency of as high as 98%. When the charge/discharge rate returned back to 1C after a total of 40 cycles, the electric capacity was recovered to 1557 mAh/g, which is 96% of the value at the first cycle.

FIB-TEM Experiment

An FIB-TEM experiment conducted after the half-cell experiment demonstrated that the internal structure of the germanium nanoparticles/carbon hybrid electrode was not changed although the germanium nanoparticles underwent a morphological change from crystalline to amorphous due to the repeated association with and dissociation from lithium. In contrast, the simply carbonized germanium nanoparticles without a polymer were coagulated.

1. A method for preparing an anode for secondary batteries, comprising: p1 mixing non-carbonaceous nanoparticles, a block copolymer, and a thermosetting resin, coating a current collector with the mixture, curing the mixture on the current collector, and carbonizing the mixture.

2. The method of claim 1, wherein the non-carbonaceous nanoparticles are made of at least one selected from the group consisting of silicon, germanium, and antimony.

3. The method of claim 1, wherein the non-carbonaceous nanoparticles are modified at their surfaces with an organic functional group.

4. The method of claim 1, wherein the block copolymer is a self-assembly copolymer containing a block compatible with the organic functional group.

5. The method of claim 1, wherein the
mixing comprises mixing the non-carbonaceous nanoparticles with the block copolymer to yield a non-carbonaceous nanoparticle-containing block copolymer; and mixing the non-carbonaceous nanoparticle-containing block copolymer with the thermosetting resin.

6. The method of claim 5, wherein the non-carbonaceous nanoparticle-containing block copolymer is mixed at a weight ratio of 20:80˜80:20 with the thermosetting resin.

7. The method of claim 1, wherein the non-carbonaceous nanoparticles range in size from 1 to 40 nm.

8. An anode for secondary batteries, comprising a current collector coated with a non-carbonaceous nanoparticle-dispersed conductive carbide film.

9. The anode of claim 8, wherein the non-carbonaceous nanoparticles are germanium nanoparticles.

10. The anode of claim 8, wherein the conductive carbide film is prepared by carbonizing a thermoset thin film in which the non-carbonaceous nanoparticles are dispersed.

11. The anode of claim 8, wherein the conductive carbide film is prepared by carbonizing a thermoset thin film made of a thermosetting resin in which a non-carbonaceous nanoparticle-containing block copolymer is dispersed.

12. A lithium polymer battery, comprising:
an anode composed of a current collector coated with a non-carbonaceous nanoparticle-dispersed conductive carbide film;
a cathode; and
an electrolyte.

13. The lithium polymer battery of claim 12, wherein the electrolyte is a mixture of PS-PEO block copolymer and PEO, with Li ions doped thereonto.

14. A method for preparing an anode for secondary batteries, comprising:
modifying non-carbonaceous nanoparticles with an organic function group;
yielding polymer particles containing the modified non-carbonaceous nanoparticles;
mixing the polymer particles with a thermoset rein to give a coating solution;
applying the coating solution to a current collector to form a thin film and drying the thin film; and
curing and carbonizing the thin film.

15. The method of claim 14, wherein the polymer particles are made of a block copolymer compatible with the organic function group.
